(19) United States
(12) Patent Application Publication
(10) Pub. No.: US 2016/0185063 A1
(43) Pub. Date: Jun. 30, 2016

(54) METHOD OF COMPACTION OF A POWDER AND A ROLLER COMPACTION DEVICE

(71) Applicant: XTRUTECH LTD., Newcastle under Lyme (GB)

(72) Inventors: Stephen Raymond Wilburn, South Shields (GB); Andrew Robert Morgan, Gateshead (GB)

(21) Appl. No.: 14/910,982

(22) PCT Filed: Aug. 5, 2014
(86) PCT No.: PCT/EP2014/066809

§ 371 Date: Feb. 8, 2016

(30) Foreign Application Priority Data
Aug. 9, 2013 (EP) 13179929.8

(51) Int. Cl. B30B 11/00; B30B 11/18

(52) U.S. Cl. CPC B30B 11/006; B30B 11/18

(57) ABSTRACT

In a method of compaction of a powder (P) by means of nip rollers the powder (P) is transported at a supply speed to the nip rollers and friction between at least one of the nip rollers and the powder (P) at said nip roller is determined. Depending on the friction the rotational speed of at least one of the nip rollers is adjusted. The supply speed of the powder (P) to the nip rollers as well as the distance between the nip rollers are maintained substantially constant.

### CROSS-REFERENCE TO RELATED APPLICATION

The present application is a national stage filing of International patent application Serial No. PCT/EP2014/066809, filed Aug. 5, 2014, and published as WO 2015/018825 A1 in English.

### BACKGROUND

The discussion below is merely provided for general background information and is not intended to be used as an aid in determining the scope of the claimed subject matter.

The present disclosure pertains to a method of compaction of a powder by means of nip rollers, wherein the powder is transported at a supply speed to a nip area between the nip rollers.

Compaction of a powder is well known in the field of powder coatings in order to re-use particles which have undesired sizes. Powder coatings are solvent-free paints comprising a mixture of polymer and optionally one or more cross linkers and/or pigments, that are applied as dry powders. Once applied to an object the powder is molten and forms a liquid film. Upon curing the film, the polymer is cross-linked and the paint film solidifies. In order to obtain a steady powder spray the particle size of the powder must be within a desired range. Relatively small or large particles may be undesired in a powder coating process.

In general, powder coatings are produced by milling which results in a relatively broad particle size range. Undesired particles at both ends of the size range may be removed and collected by means of a classifier and a cyclone. Preferably, the collected powder waste is re-used for the powder coating process. A suitable option to re-use the powder waste is compaction or dry bonding using nip rollers in order to form a hard solid that can directly be re-milled or re-ground to form a powder coating. This means that the compacted powder can be returned to the milling device during the same production batch. In order to form a hard solid from a compacted fine powder significant pressure is required. However, a too high pressure may cause premature melting due to a temperature increase of the compacted powder, hence requiring additional cooling, and a too low pressure may generate too small particles during re-milling.

The physical properties of fine particles that are generated during production of powder coatings vary significantly, for example in respect of their size distribution, average size, fluidity, bulk density, polymer content, etc. There are several ambient conditions which affect their properties, such as temperature and humidity, but their properties may also vary over time due to settling.

Due to the pressure at the nip rollers the particles undergo plastic deformation and fracture at the inter-particle contact points and particles bond to each other. The strength of the bond depends on the inter particle area that deforms. In general the strength of the compacted product depends on the particle size distribution, shape and the elasticity modulus of the material. In practice, a pressure of 15-20 kN per cm roller width appears to yield a hard compacted product.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter. The claimed subject matter is not limited to implementations that solve any or all disadvantages noted in the background.

A method of compaction of powder waste wherein friction between at least one of the nip rollers and the powder at said nip roller is determined, and wherein depending on the friction the rotational speed of at least one of the nip rollers is adjusted whereas the supply speed of the powder to the nip rollers as well as the distance between the nip rollers are maintained substantially constant.

An advantage of the method disclosed is that it can be automated easily in a closed loop control which requires minimum operator intervention. Determining the friction basically means that the variation in powder quality fed to the nip rollers is monitored. Maintaining the supply speed of the powder to the nip rollers as well as the distance between the nip rollers substantially constant is advantageous in that varying the supply speed can change the fluidity of the powder which may lead to a method which is more difficult to control automatically, whereas variation of the distance between the nip rollers requires a relatively complex compaction device.

In principle, the friction can be determined by determining the reaction force by the nip roller exerted on the powder. The force can be derived by means of a force sensor or a strain gauge, for example.

In an advantageous embodiment the nip roller is driven by an electric motor and the friction is derived by determining the electrical power consumption of the electric motor. This is a rather simple method of deriving the friction at a certain speed of the nip roller.

The rotational speed of the nip roller may be adjusted on the basis of the friction at the nip roller. This means that determining the friction as well as controlling the speed is performed at the same nip roller.

It is advantageous to drive the nip rollers independently from each other since this provides a great freedom of process control. For example, it may be desired to operate the nip rollers at different speeds.

In a specific embodiment the friction levels between the powder and both nip rollers are determined and the rotational speeds of both nip rollers are adjusted independently from each other. For example, it provides the opportunity to take into account wear of each of the nip rollers which may require a different speed control of the respective nip rollers.

In general, the rotational speeds of the nip rollers will be increased if the friction at the nip rollers increases. Due to the higher speed the compaction pressure will reduce. When the compaction pressure becomes too low the friction will decrease below a certain value and the rotational speed of the nip rollers may be reduced to compensate this effect.

An aspect of the invention is also related to a roller compaction device for compaction of a powder, which comprises nip rollers and a feeder for transporting a powder to a nip area between the nip rollers, a sensing apparatus for determining friction between at least one of the nip rollers and the powder at the nip roller, and a controller for adjusting the rotational speed of at least one of the nip rollers, depending on the friction level, whereas the speed of the feeder as well as the distance between the nip rollers is substantially constant.

The nip roller may be driven by an electric motor, wherein measurement devices for determining the electrical power consumption and speed of the electric motor are connected to the controller. The signals from the measurement devices, for example an electrical current detector, volt meter and a speed sensor, are used as input signals for a control program in the controller.

The circumferential surfaces of the nip rollers may be smooth, which means that the surfaces lack a macroscopic embossing or texture. This is advantageous for obtaining a consistent hard solid product which is particularly suitable for re-grinding.

In a particular embodiment one of the nip rollers has a diabolo-shape, whereas the other nip roller has frustoconical opposite axial end portions which are shaped complementarily. This reduces loss of powder at the axial ends of the nip rollers compared to entirely cylindrical nip rollers. It is noted that these shapes of the nip rollers may be applied to any other roller compaction device including nip rollers, independent from the presence of the sensing apparatus and the controller.

The method disclosed does not determine the properties of the resulting product, but it determines a process parameter during manufacturing, i.e. friction between a roller and the powder. An advantage of controlling the process on the basis of a parameter further upstream in the process such as in the method disclosed provides a faster system control.

The method disclosed, however, does control the nip roller speed, whereas the supply speed of the powder to the nip rollers as well as the distance between the nip rollers are maintained substantially constant.

### BRIEF DESCRIPTION OF THE DRAWINGS

Aspects of the invention will hereafter be elucidated with reference to drawings illustrating an embodiment of the invention schematically.

FIG. 1 is an illustrative side view of an embodiment of a compaction device.

FIG. 2 is an enlarged view of a part of the embodiment as shown in FIG. 1.

FIG. 3 is a bottom view of the embodiment of FIG. 1.

FIG. 4 is a block diagram, illustrating an embodiment of the method of compaction of the powder by means of the compaction device as shown in FIG. 1.

### DETAILED DESCRIPTION OF THE ILLUSTRATIVE EMBODIMENTS

Powder coatings which are produced by milling result in a relatively broad size range. Particles at both ends of the size range that are undesired for the powder coating process are removed and collected. The collected powder waste can be re-used for the powder coating process by compaction or dry bonding in order to form a hard solid that can be directly re-milled or re-ground to form a powder coating. This means that the compacted powder can be returned to the milling device during the same production batch.

FIG. 1 shows an embodiment of a roller compaction device 1. The roller compaction device 1 comprises two counter-rotating nip rollers 2, 3 as indicated by arrows in FIG. 1. A powder P, for example fine polymeric particles that may be smaller than 10 μm, is fed to a storage device, in this case a hopper 4. The nip rollers 2, 3 are driven separately by electric motors (not shown). This means that the nip rollers 2, 3 can be driven independently from each other.

The powder P is transported from the hopper 4 to a nip area between the nip rollers 2, 3 by means of a feed screw 5. In this embodiment the feed screw 5 runs at a fixed speed such that the powder P is transported at a constant supply speed to the nip rollers 2, 3. In an alternative embodiment the feed screw 5 may be operated at a variable speed, if desired. When the powder P is transported by the feed screw 5 air can be removed and the bulk density may be increased without deforming the particles. Additionally, vibration and/or vacuum filtration may be applied to increase the bulk density at the feed screw 5.

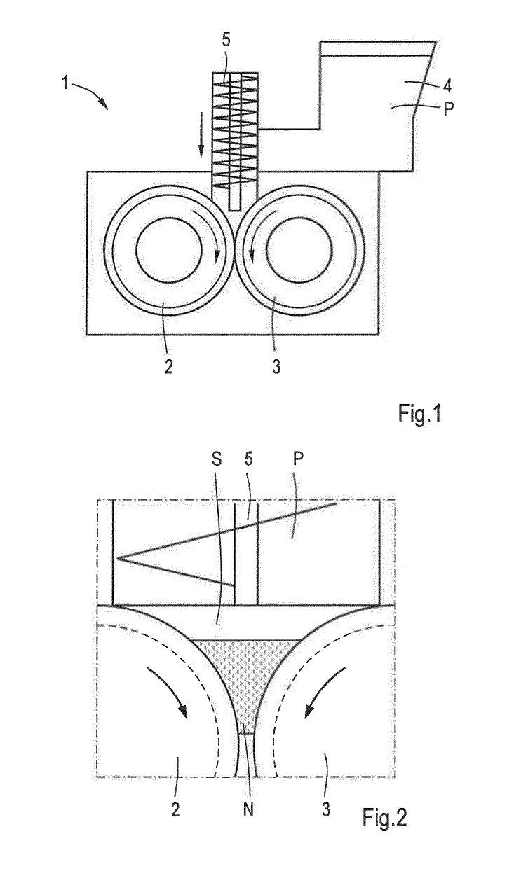

FIG. 2 shows a transport region of the powder P between the feed screw 5 and a narrowest gap between the nip rollers 2, 3 in more detail. The powder P passes a slip region S and subsequently a nip region N. In the nip region N the powder moves at substantially the same speed as the circumferential speeds of the nip rollers 2, 3. In the nip region N the fine particles are compressed such that they form a hard sheet when leaving the narrowest gap between the nip rollers 2, 3. In practice the sheet may have a thickness of 5-10 mm, but a thinner or thicker sheet is conceivable. In the embodiment as shown in FIGS. 1 and 2 the narrowest gap is constant since the relative positions of the nip rollers 2, 3 are fixed, but in an alternative embodiment the distance between the nip rollers 2, 3 may be adjustable.

The process of compaction of the powder P can be controlled in order to maintain an appropriate quality of the resulting sheet of compacted powder. In the embodiment as shown in FIGS. 1 and 2 the quality is maintained by determining friction between the powder P and the nip rollers 2, 3 and controlling the rotational speed of the respective nip rollers 2, 3. The friction level is determined by measuring the electrical power consumption of the respective electric motors at their respective speeds. The friction level between the powder P and a nip roller at a certain rotational speed thereof is higher when the measured electrical power consumption is higher. The force by the corresponding nip roller exerted on the powder P at the corresponding speed of the nip roller is indirectly measured in this way. In an alternative embodiment the force can be derived by measuring the reaction force in said nip roller, for example by means of a strain gauge.

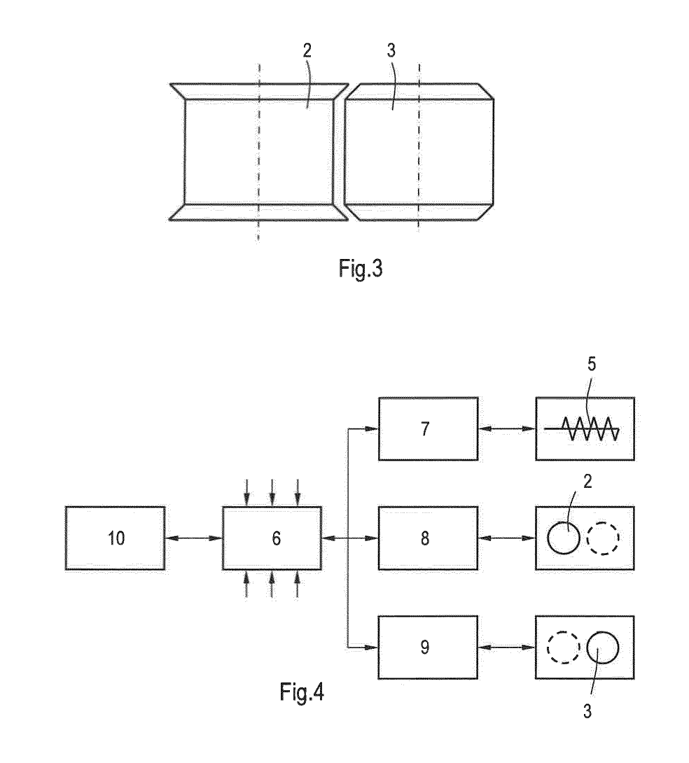

FIG. 3 shows the nip rollers 2, 3 separately as seen from below in FIG. 1. It can be seen that the nip rollers 2, 3 have cylindrical center portions whereas the respective axial end portions are shaped differently. One of their nip rollers 2 has a diabolo-shape, whereas the other nip roller 3 has frustoconical opposite axial end portions which are shaped complementarily. In other words, each of the nip rollers 2, 3 has opposite tapered axial end portions, converging in outward direction at one of the nip rollers 3 and diverging in outward direction at the other nip roller 2. It appears that the end portions shaped in this way minimize loss of the powder P at the axial ends of the nip rollers 2, 3. The nip rollers 2, 3 have smooth circumferential surfaces, but in an alternative embodiment the nip rollers 2, 3 may be provided with embossed surfaces.

The roller compaction device 1 is also provided with a controller 6 for adjusting the rotational speeds of the nip rollers 2, 3. FIG. 4 shows a block diagram that illustrates how the controller 6 works in a schematic way. In this embodiment the controller 6 comprises a PLC (Programmable Logic Controller) or PAC (Programmable Automation Controller) which controls a first drive control 7 for setting the speed of the feed screw 5, a second drive control 8 for setting the rotational speed of the electric motor of one of the nip rollers 2 and a third drive control 9 for setting the rotational speed of the electric motor of the other nip roller 3. The electric motors may be controlled by means of a variable frequency inverter drive in order to be able to adjust their rotational speeds. The controller 6 is also provided with a user interface 10 which provides an operator information in respect of several process parameters.

FIG. 4 shows six relevant input signals to the PLC 6: two actual speed levels of the respective electric motors, and two actual voltage and electrical current levels to the respective electric motors. The actual input signal values are compared with desired values, possibly after converting the values to physical parameters. If the controller 6 detects a difference between the actual level and the desired level of a certain parameter the rotational speed of one or both nip rollers 2, 3 is adjusted. For example, if at a certain rotational speed of both nip rollers 2, 3 the electrical current to both electric motors is higher than a desired value at that speed, the friction between the nip rollers 2, 3 and the powder P has become too high and the controller 6 increases the speeds of the nip rollers 2, 3.

1. A method of compaction of a powder (P) by means of nip rollers, wherein the powder (P) is transported at a supply speed to a nip area between the nip rollers and friction between at least one of the nip rollers and the powder (P) at said nip roller is determined, wherein depending on the friction the rotational speed of at least one of the nip rollers is adjusted, whereas the supply speed of the powder (P) to the nip rollers as well as the distance between the nip rollers are maintained substantially constant.

2. The method according to claim 1, wherein the friction is determined by means of determining the force by said nip roller exerted on the powder (P) at a certain speed of the nip roller.

3. The method according to claim 2, wherein the force is derived by measuring a reaction force in said nip roller.

4. The method according to claim 2, wherein said nip roller is driven by an electric motor and the force is derived by determining the electrical power consumption of the electric motor at a certain speed thereof.

5. The method according to one of the preceding claims, wherein the rotational speed of said nip roller is adjusted on the basis of the friction at said nip roller.

6. The method according to one of the preceding claims, wherein the nip rollers are driven independently from each other.

7. The method according to claim 6, wherein the friction levels between the powder (P) and both nip rollers are determined and the rotational speeds of both nip rollers are adjusted independently from each other.

8. A roller compaction device (1) for compaction of a powder (P), comprising nip rollers and a feeder for transporting a powder (P) to a nip area between the nip rollers, a sensing apparatus for determining the friction between at least one of the nip rollers and the powder (P) at said nip roller, and a controller for adjusting the rotational speed of at least one of the nip rollers, depending on the friction, whereas the speed of the feeder as well as the distance between the nip rollers is substantially constant.

9. The roller compaction device according to claim 8, wherein said nip roller is driven by an electric motor, and wherein measurement devices for determining the electrical power consumption and speed of the electric motor are connected to the controller.

10. The roller compaction device according to claim 8, wherein the circumferential surfaces of the nip rollers are smooth.

11. The roller compaction device according to claim 8, wherein one of the nip rollers has a diabolo-shape, whereas the other nip roller has frustoconical opposite axial end portions which are shaped complementarily.

12. The roller compaction device according to claim 9, wherein one of the nip rollers has a diabolo-shape, whereas the other nip roller has frustoconical opposite axial end portions which are shaped complementarily.

13. The roller compaction device according to claim 10, wherein one of the nip rollers has a diabolo-shape, whereas the other nip roller has frustoconical opposite axial end portions which are shaped complementarily.

14. The roller compaction device according to claim 9, wherein the circumferential surfaces of the nip rollers are smooth.
